(19) United States
(12) Patent Application Publication
(10) Pub. No.: US 2015/0108944 A1
(43) Pub. Date: Apr. 23, 2015

(54) WIRELESS CHARGING METHOD AND DEVICE

(71) Applicant: SHENZHEN FEIFAN INDUSTRIAL CO., LTD., Shenzhen, Guangdong (CN)

(72) Inventor: Huabin Mai, Shenzhen (CN)

(73) Assignee: SHENZHEN FEIFAN INDUSTRIAL CO., LTD., Shenzhen, Guangdong (CN)

(21) Appl. No.: 14/396,558

(22) PCT Filed: Dec. 20, 2012
(86) PCT No.: PCT/CN2012/087056

§ 371 Date: Oct. 23, 2014

(30) Foreign Application Priority Data
Apr. 24, 2012 (CN) 201210123201.1

(51) Int. Cl. H02J 7/02

(52) U.S. Cl. CPC H02J 7/025
USPC 320/108; 320/137

(57) ABSTRACT

A wireless charging method and device have been disclosed. The wireless charging device includes at least two electrodes arranged separately and used for contact with a conductive contact of a power receiving device, and a power supply circuit that is electrically connected to the electrodes and supplies power according to association between all electrodes in contact with the conductive contact. The method includes the following steps: S1: setting electrodes of a wireless charging device to a detection state; S2: detecting whether the electrodes are in contact with a conductive contact of a power receiving device; S3: determining association between all electrodes in contact with the conductive contact, and setting polarity of the electrodes respectively; and S4: connecting a power supply corresponding to the polarity according to the polarity of the electrodes. The method and device have advantages of convenient use and ideal universality.

### TECHNICAL FIELD

This disclosure relates to charging devices, and more particularly to wireless charging methods and devices.

### BACKGROUND

With developments in science and technology, more and more electric equipments are used in people's life. During their usage, the electric equipments or batteries thereof are powered by directly connecting to a power source through a power plug. There will thus be increasing power plugs with the increasing electric equipments. This may bring about inconvenient operation to users.

In addition, different electric equipments usually employ different power plugs, and thus an adapter should be equipped for adapting different power plugs. Therefore, the user has to use many power adapters, which not only goes against energy conservation and environment protection but also results in huge wasting of resources.

Besides, when it is needed to charge a plurality of electric equipments at the same time, a plurality of power adapters are used simultaneously and power strip(s) is/are additionally employed in this case. Moreover, connection lines of the power adapters easily twist with each other, thus causing inconvenience in the usage to the users.

### SUMMARY OF THIS DISCLOSURE

The technical problem to be solved in this disclosure is to provide wireless charging methods and devices with convenient operation and excellent universality.

According to one aspect, a wireless charging method is provided for solving above technical problem. The method includes the following steps:

S1: setting electrodes of a wireless charging device to a detection state;

S2: detecting whether the electrodes are in contact with a conductive contact of a power receiving device;

S3: determining association between all the electrodes that are in contact with the conductive contact, and setting polarity of these electrodes respectively; and

S4: connecting to a power source corresponding to the polarity according to the polarity of the electrodes.

In the wireless charging method of this disclosure, a micro voltage is loaded onto the electrodes so as to make the electrodes be in a to-be-detected state in the step S1.

In the wireless charging method of this disclosure, the electrodes are determined to be in contact with the conductive contact in the step S2 when the micro voltage on the electrodes changes.

In the wireless charging method of this disclosure, there are a plurality of the electrodes.

In the step S3, one of the electrodes which is in contact with the conductive contact is taken as a reference, while scanning the remaining electrodes successively, wherein the electrode(s) in short connection with the electrode as the reference is/are set as a same polarity while the electrode(s) not in short connection with the electrode as the reference is/are set as a different polarity.

In the wireless charging method of this disclosure, each of the electrodes is connected with a positive switching circuit and a negative switching circuit.

In the step S4, the positive switching circuit or the negative switching circuit correspondingly connected with the electrodes is controlled to be switched on according to the polarity set in the step S3 so as to connect the power receiving device to the power source.

According to another aspect, a wireless charging device is further provided, which includes at least two electrodes and a power supply circuit. The at least two electrodes are arranged separately and operable for contacting with a conductive contact of a power receiving device. The power supply circuit is electrically connected with the electrodes and is operable to supply power according to association between all the electrodes that are in contact with the conductive contact.

In the wireless charging device of this disclosure, the power supply circuit includes a detection circuit, a switching circuit, a control circuit and a power circuit, wherein the power circuit is connected with the detection circuit, the switching circuit and the control circuit for supplying power.

The detection circuit is electrically connected with each of the electrodes for detecting whether the electrodes are in contact with the conductive contact.

The switching circuit is electrically connected with each of the electrodes for switching on or switching off the power supplied to the electrodes.

The control circuit is connected with the detection circuit and the switching circuit, wherein based on whether each of the electrodes is in contact with the conductive contact detected by the detection circuit, the control circuit is operable to send out a control signal to the switching circuit so that each of the electrodes is controlled to connect to or disconnect from the power circuit.

In the wireless charging device of this disclosure, the control circuit includes a detection setting module. The detection setting module is operable to take one of the electrodes that is in contact with the conductive contact as a reference while scanning the remaining electrodes, wherein the electrode(s) in short connection with the electrode as the reference is/are set as a same polarity and the electrode(s) not in short connection with the electrode as the reference is/are set as a different polarity.

The control module is operable to output an on-off control signal to the switching circuit according to a setting result of the detection setting module.

In the wireless charging device of this disclosure, the switching circuit includes a positive switching circuit and a negative switching circuit which are simultaneously connected with each of the electrodes.

The detection circuit includes a plurality of detection units, wherein each of the detection units is electrically connected with one of the electrodes.

The positive switching circuit includes a plurality of positive switching units, where each of the positive switching units is electrically connected with one of the electrodes.

The negative switching circuit includes a plurality of negative switching units, where each of the negative switching units is electrically connected with one of the electrodes.

The positive switching unit and the negative switching unit connected with the same electrode are controlled by the control circuit to be alternatively switched on or simultaneously switched off

In the wireless charging device of this disclosure, the electrodes and the power supply circuit are integrally arranged with each other. Alternatively, the electrodes and the power supply circuit are separately arranged and electrically connected with each other through wire or contact.

When implementing this disclosure, the following advantageous effects can be achieved: whether the electrode is powered on or the polarity of the electrode is set by detecting the status of the conductive contact on the electrode of the wireless charging device, and the association between the electrode and the conductive contact can be matched automatically, so that the power supply can be achieved by freely placing the power receiving device on the wireless charging device, thus having the advantages of convenient operation and excellent universality.

Additionally, a plurality of power receiving devices can be simultaneously placed on the wireless charging device by arranging a plurality of electrodes. In this way, the a plurality of power receiving devices can be powered simultaneously, thereby avoiding the inconvenience of using a plurality of power adapters in the prior art.

### BRIEF DESCRIPTION OF THE DRAWINGS

Below this disclosure will be further described with reference to accompanying drawings and embodiments. In the figures:

FIG. 1 is a schematic diagram for an embodiment of a wireless charging device in this disclosure;

FIG. 2 is a schematic diagram illustrating round electrodes of a wireless charging device in this disclosure;

FIG. 3 is a schematic diagram illustrating rectangle electrodes of a wireless charging device in this disclosure;

FIG. 4 is a schematic diagram illustrating round electrodes in staggered arrangement of a wireless charging device in this disclosure;

FIG. 5 is a schematic block diagram for a wireless charging device in this disclosure;

FIG. 6 is a schematic diagram for an embodiment of a power receiving device in this disclosure;

FIG. 7 is a schematic diagram illustrating one state in which a power receiving device is placed on a wireless charging device in this disclosure;

FIG. 8 is a schematic diagram illustrating another state in which a power receiving device is placed on a wireless charging device in this disclosure;

FIG. 9 is a schematic diagram illustrating a working process of a power receiving device in this disclosure;

FIG. 10 is a schematic diagram illustrating round electrodes in another embodiment of a wireless charging device in this disclosure;

FIG. 11 is a schematic diagram illustrating rectangle electrodes in another embodiment of a wireless charging device in this disclosure.

### DETAILED DESCRIPTION

As shown in FIGS. 1-4, one embodiment for a wireless charging device 100 of this disclosure is represented. The wireless charging device 100 can be used for providing a power receiving device with a power supply platform so as to facilitate the usage of the power receiving device.

The wireless charging device 100 includes a support main body 110. A plurality of electrodes 111 are disposed on a surface of the support main body 110, and an insulation gap 112 is located between the electrodes 111 to respectively separate the a plurality of electrodes 111. The electrodes 111 can each connect to a charging power source for being powered by accessing the power source.

As shown in figures, the support main body 110 in this embodiment is a flat-panel main body, of which the shape and the size can be adjusted as required.

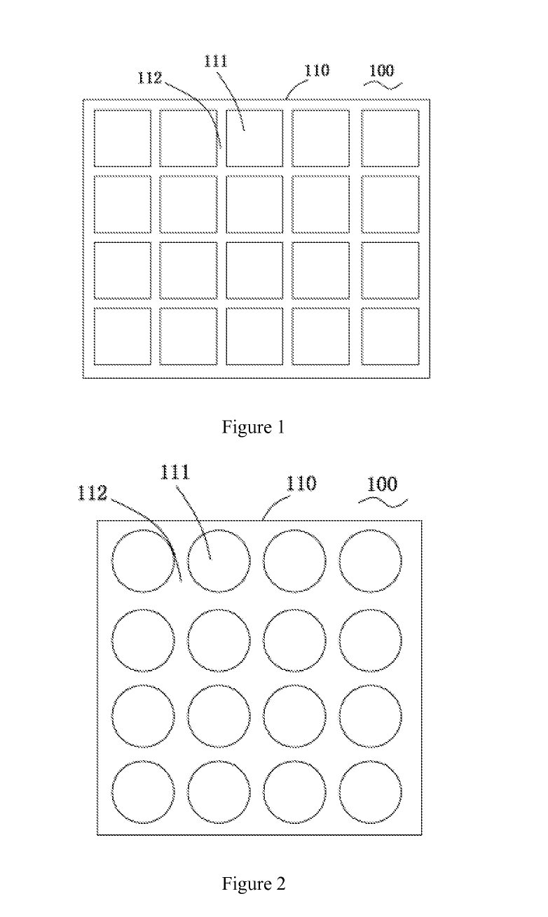

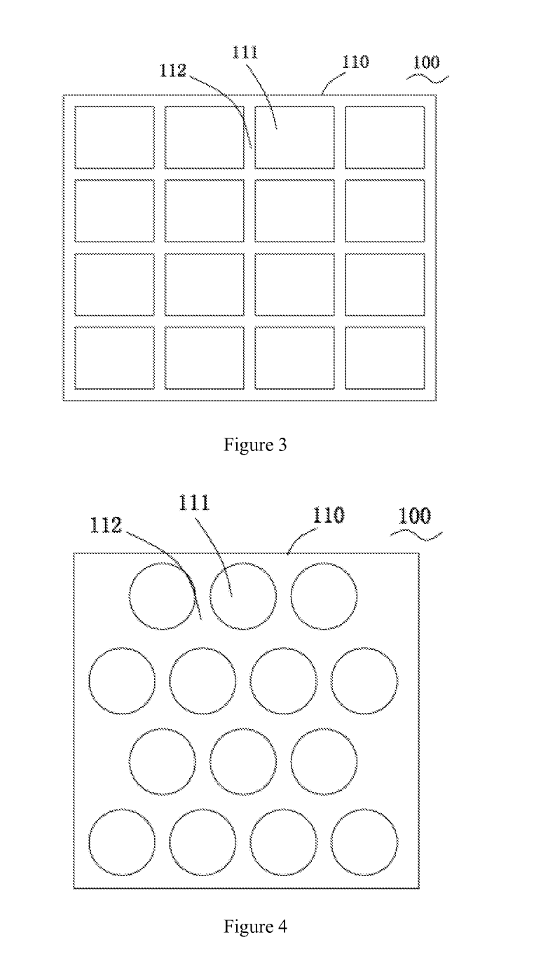

The electrodes 111 which are square-shaped are arranged in matrix form with equal spacing on the support main body 110. It can be understood that the electrodes 111 can be set to have any other shape as required, such as round shape (as shown in FIG. 2), rectangle shape (as shown in FIG. 3), prismatic shape, trapezoid shape, and irregular shape and so on.

For facilitating the arrangement of the electrodes 111, the electrodes 111 are usually arranged to be regularly and equally spaced. In some circumstance in need of special design, those electrodes 111 can also be arranged irregularly or without equal spacing. As shown in FIG. 4, it is a schematic diagram illustrating the electrodes 111 in staggered arrangement.

Further, the number of the electrodes 111 can be designed based on actual needs, as long as at least two electrodes are included in the wireless charging device. In this embodiment, the support main body 110 is an insulated flat-panel main body. The electrodes 111 are directly affixed on the surface of the support main body 110, and then the insulation gap 112 is naturally formed between the electrodes 111. Some recesses and/or clamping elements can also be disposed on the support main body 110, where the electrodes 111 are embedded and fixed on the support main body 110. Besides, insulation paste can be filled between the electrodes 111 to prevent the short connection between the electrodes 111.

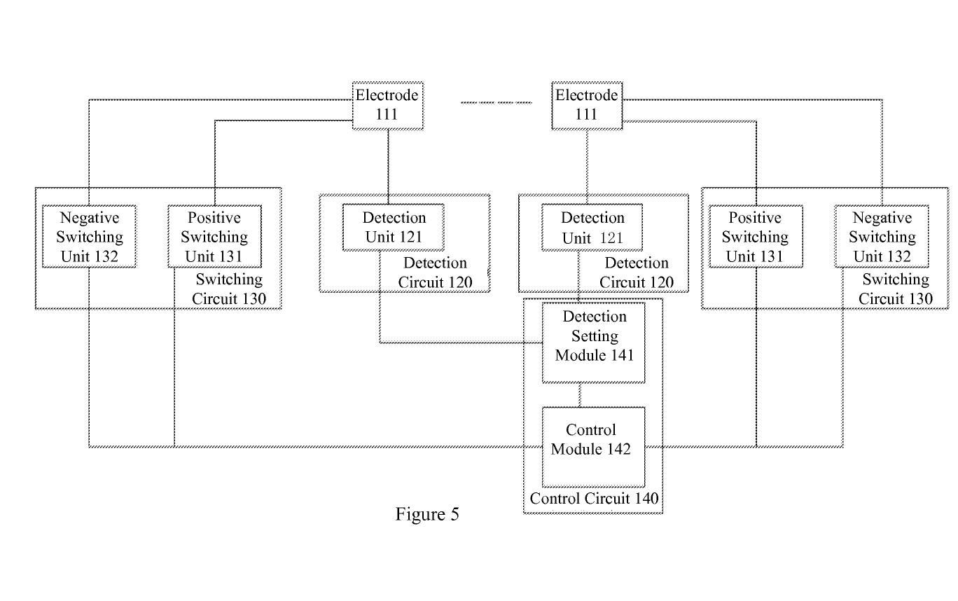

As shown in FIG. 5, the electrodes 111 of the wireless charging device 100 are connected to a power supply circuit which supplies power based on the association between all the electrodes that are in contact with conductive contact(s). Besides, the power supply circuit can be directly disposed within the support main body 110. Alternatively, the power supply circuit can be disposed within an independent housing and then electrically connected with the electrodes 111 through wire, flat cable or contact.

The power supply circuit includes a detection circuit 120, a switching circuit 130, a control circuit 140 and a power circuit, wherein the power circuit is connected with the detection circuit 120, the switching circuit 130 and the control circuit 140 for supplying power.

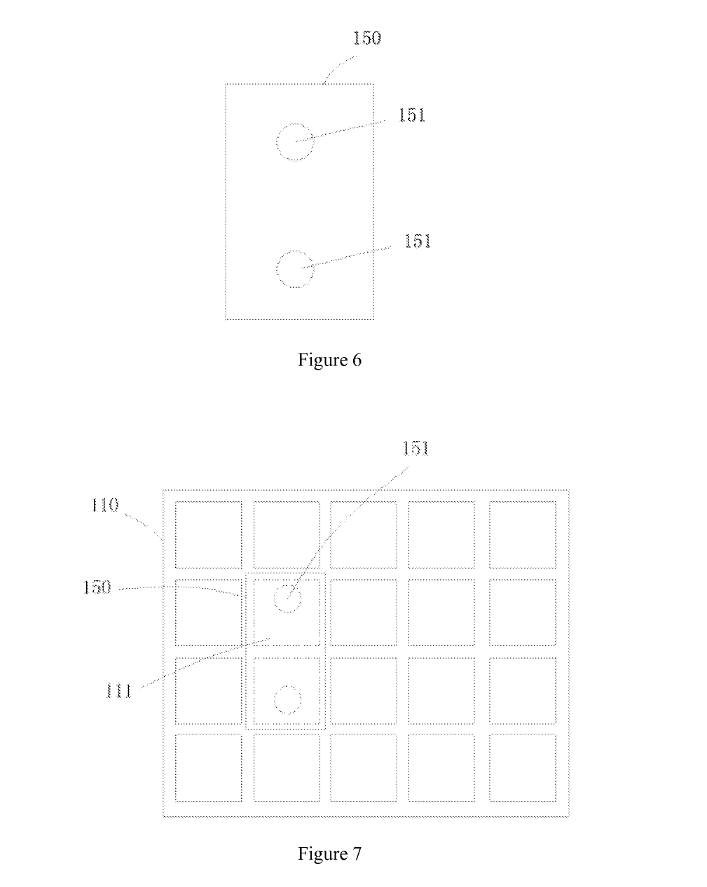

Referring to FIGS. 5 and 6, the detection circuit 120 is electrically connected with each electrode 111 for detecting whether the electrodes 111 are in contact with the conductive contact(s) 151. The detection circuit 120 includes a plurality of detection units 121, where each of the detection units 121 is electrically connected with one electrode 111 correspondingly. A micro voltage is loaded onto the electrodes 111 by the detection unit 121, so that each of the electrodes 111 is in a to-be-detected state and whether the electrode is in contact with the conductive contact 151 is detected. Furthermore, when there is the conductive contact 151 for contacting, trigger signal is generated to the control circuit 140 for further determination and setting.

The switching circuit 130 is electrically connected with each electrode 111 for switching on or switching off the power supplied to the electrodes 111. In this embodiment, the switching circuit 130 includes a positive switching circuit and a negative switching circuit which are simultaneously connected with each electrode 111. The positive switching circuit or the negative switching circuit is selected by the control circuit 140 to operate for connecting to the corresponding electrode 111.

In this embodiment, the positive switching circuit includes a plurality of positive switching units 131, where each of the positive switching units 131 is electrically connected with one of the electrodes 111. The negative switching circuit includes a plurality of negative switching units 132, where each of the negative switching units 132 is electrically connected with one of the electrodes 111. Each electrode 111 correspondingly connects with one positive switching unit 131 and one negative switching unit 132 for freely setting the polarity of the electrode 111.

The control circuit 140 is connected with the detection circuit 120 and the switching circuit 130, wherein based on whether each of the electrodes 111 is in contact with the conductive contact 151 detected by the detection circuit 120, the control circuit 140 is operable to send out a control signal to the switching circuit 130 so that each of the electrodes 111 is controlled to connect to or disconnect from the power circuit. In this embodiment, in order to set the polarity of the electrodes 111, the positive switching unit 131 and the negative switching unit 132 connected with the same electrode 111 are controlled by the control circuit 140 to be alternatively switched on or simultaneously switched off.

As shown in FIG. 5, the control circuit 140 includes a detection setting module 141 and a control module 142. The detection setting module 141 is connected with the detection circuit 120. Based on the trigger signal inputted from the detection circuit 120, the detection setting module 141 is operable to take one of the electrodes 111 that is in contact with the conductive contact 151 as a reference while scanning the remaining electrodes 111, wherein the electrode(s) 111 in short connection with the electrode 111 as the reference is/are set as a same polarity and the electrode(s) 111 not in short connection with the electrode 111 as the reference is/are set as a different polarity.

The control module 142 is connected with the switching circuit 130 and the detection setting module 141, and it is operable to output an on-off control signal to the switching circuit 130 according to a setting result of the detection setting module 141, so that the switching circuit 130 can control the disconnection or the polarity for connection of the corresponding electrode(s) 111.

Besides, it is needed to note that the polarity of the conductive contact in contact with the electrode (i.e., the polarity of an input port of the power module in connection with the conductive contact) can be detected by the detection unit of the corresponding power supply circuit after the electrode is in contact with the conductive contact of the power receiving device. When the polarity is detected to be a positive electrode, the corresponding positive switching unit is controlled to be switched on so as to connect the electrode with a positive output end of the power circuit. On the other hand, when the polarity is detected to be a negative electrode, the corresponding negative switching unit is controlled to be switched on so as to connect the electrode with a negative output end of the power circuit. Alternatively, the power supply circuit may also not detect the polarity of the conductive contact in contact with the electrode. Instead, the electrode is randomly allocated by the control circuit to connect with the positive output end or the negative output end of the power circuit, while the polarity of the electrode in contact with the conductive contact (i.e., the polarity of the output end of the power circuit in connection with this electrode) is detected within the power receiving device, and the two output ends of the power circuit are then correspondingly connected to two input ends of the power module.

Further, for the purpose of ensuring secure and stable operation of the wireless charging device 100, the wireless charging device 100 can also include a safety protection circuit, an over-current protection circuit and a power sensing circuit.

As shown in FIG. 6, it is a schematic diagram for an embodiment of the power receiving device 150 in this disclosure. This power receiving device can cooperate with the above-described wireless charging device 100. With reference to FIG. 7, the power receiving device 150 includes two conductive contacts 151, which can be in contact with the electrodes 111 of the wireless charging device 100 such that power is supplied to the power receiving device 150 through connecting to a power source. Aiming at convenient operation, more than two conductive contacts 151 can also be arranged as required, undoubtedly.

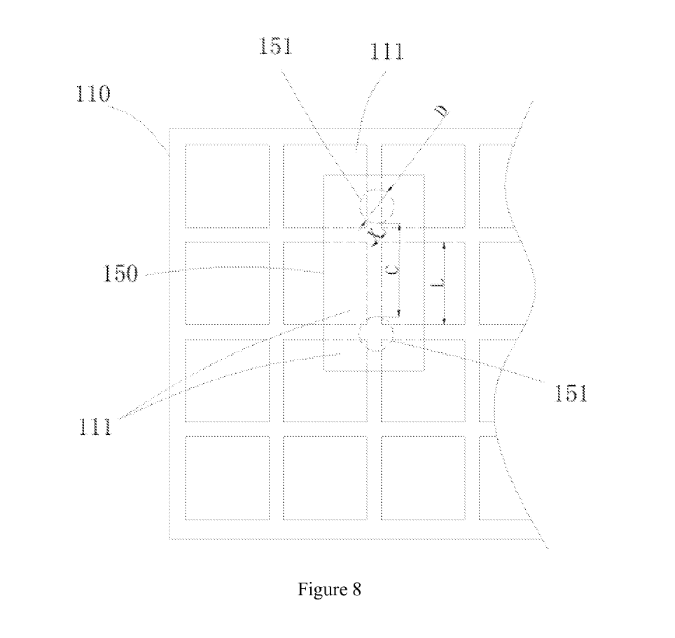

Please referring to FIG. 8, such two conductive contacts 151 are needed to cooperate with the electrodes 111 of the wireless charging device 100. The smallest edge distance D of a single conductive contact 151 is larger than the size X of the insulation gap 112 between the electrodes 111, such that the whole conductive contact 151 is avoided to fall into the insulation gap 112, thereby ensuring that the conductive contact 151 always has electrical contact with the electrode(s) 111 when the power receiving device 150 is placed on the support main body 110.

Meanwhile, the smallest distance C between edges of adjacent conductive contacts 151 is larger than a largest edge distance L of a single electrode 111, thus ensuring the adjacent conductive contacts 151 are prevented from electrically contacting with a same electrode 111. That is, the two adjacent conductive contacts 151 are ensured to have electrical contact with two different electrodes 111. In this way, two electrodes 111 can be set as different polarities to form a power supply loop.

The power receiving device 150 further includes a power module connected with the conductive contact 151. The power module includes one or more of toy, game equipment, cell phone, battery, charger, handheld equipment, electric tool, power connector, electric cup, music player, camera, calculator, remote controller, video tape recorder, video player, fax machine, PDA beauty equipment, electric shaver, electric tooth brush, electric hair cutter, television, refrigerator. The power module is directly powered by connecting to the power source through the conductive contacts 151.

In another implementation, the power receiving device 150 can include a housing. The conductive contacts 151 are disposed on a back surface or any other position of the housing. Meanwhile, an interface module electrically connected with the conductive contact 151 is disposed within the housing. The housing is matched with the shape of some electronic equipment (such as cell phone, PDA, tablet computer etc.), and the interface module is matched with a charging interface of the electronic equipment. The housing is sleeved onto the periphery of the electronic equipment while the interface module is inserted into the charging interface of the electronic equipment. In this way, the power source can be accessed by the conductive contacts 151 and transmitted to the electronic equipment through the interface module, and thus the electronic equipment is powered.

A wireless charging system is consisted of the above-described wireless charging device 100 and power receiving device 150. During operation, the power receiving device 150 is directly placed on the wireless charging device 100, and two conductive contacts 151 of the power receiving device 150 respectively have electrically contacted with at least two electrodes 111 of the wireless charging device 100. In this way, the power receiving device 150 is powered by the wireless charging device 100.

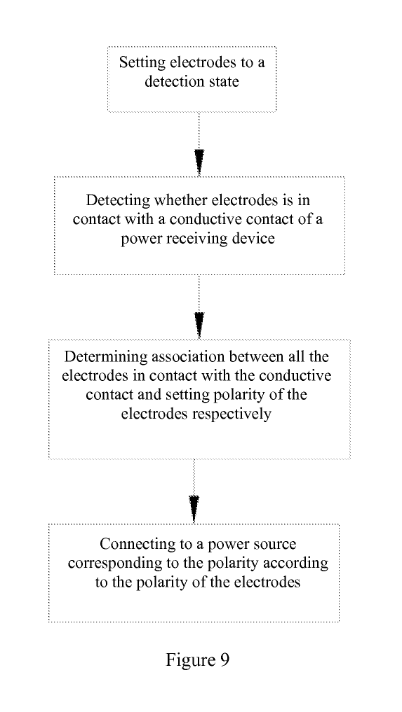

As shown in FIG. 9, when using such wireless charging system for wireless charging operation, the electrodes 111 of the wireless charging device 100 are first set to a detection state. In this embodiment, each detection unit 121 of the detection circuit 120 loads a micro voltage onto the electrodes 111 correspondingly connected with the detection unit, so as to make each electrode 111 be in a to-be-detected state.

Subsequently, whether the electrodes 111 are in contact with the conductive contact 151 of the power receiving device 150 is detected. When the electrode 111 is in contact with the conductive contact 151, its micro voltage may change, and the trigger signal is thus generated and sent to the control circuit 140. After receiving the trigger signal, the control circuit 140 can then determine whether the electrode 111 is in contact with the conductive contact 151.

After that, association between all the electrodes 111 that are in contact with the conductive contact 151 is determined, and the polarity of the electrodes 111 is set respectively. In this embodiment, based on the trigger signal from the detection unit 121, the detection setting module 141 of the control circuit 140 takes one of the electrodes 111 that is in contact with the conductive contact 151 as the reference while successively scanning the remaining electrodes 111, wherein the electrode(s) 111 in short connection with the electrode 111 as the reference is/are set as a same polarity and the electrode(s) 111 not in short connection with the electrode 111 as the reference is/are set as a different polarity. As shown in FIGS. 7 and 8, they illustrate several contact situations between the electrodes 111 and the conductive contacts 151. When two conductive contacts 151 are respectively in contact with two electrodes 111 as shown in FIG. 7, the polarity of the two electrodes 111 can be simply set as one positive electrode and one negative electrode. As what is shown in FIG. 8, when the conductive contact 151 is simultaneously in contact with a plurality of electrodes 111, all these electrodes 111 are set to have the same polarity, and the a plurality of electrodes 111 simultaneously operate for power supply.

It can be understood that when a plurality of power receiving devices 150 are placed on the wireless charging device 100 at the same time, those operations described above can also be performed to set the polarity, and the a plurality of power receiving devices 150 can be powered simultaneously.

According to the polarity set for the electrodes 111, the power source corresponding to the polarity is then connected. In this embodiment, since each electrode 111 is connected with the positive switching unit 131 of the positive switching circuit and the negative switching unit 132 of the negative switching circuit, the control module 142 of the control circuit 140 sends corresponding control signal to the positive switching unit 131 and the negative switching unit 132 during the control process, and the positive switching circuit or the negative switching circuit correspondingly connected with the electrode 111 is thus controlled to be switched on, such that a power supply loop is achieved to connect the power receiving device 150 to the power source.

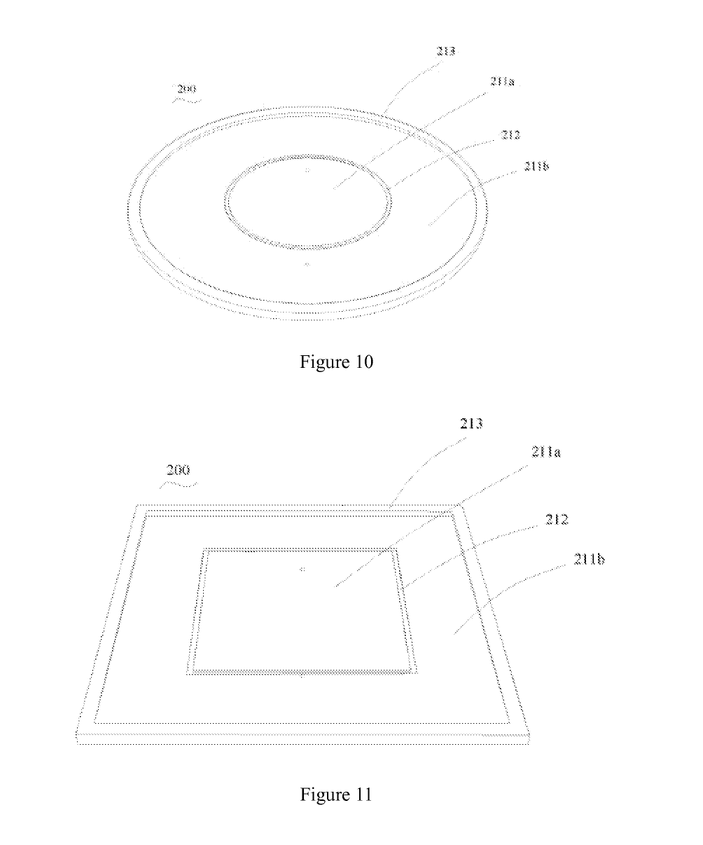

As shown in FIGS. 10 and 11, they are schematic diagrams for another embodiment of a wireless charging device 200 in this disclosure. Electrodes on a support main body of this wireless charging device 200 include a first electrode 211a and a second electrode 211b. The second electrode 211b surrounds the periphery of the first electrode 211a, and an insulation gap 212 is located between the first electrode 211a and the second electrode 211b. Insulation material can be filled into the insulation gap 212. Alternatively, when the support main body is made of insulation material, the insulation gap can be left empty.

In this embodiment, both the first electrode 211a and the second electrode 211b can adopt regular shapes such as round shape (FIG. 10) or square shape (FIG. 11). Any other shape such as ellipse, prismatic shape, trapezoid shape, irregular shape can also be used.

As shown in figures, the insulation gap 212 has equal distance between the first electrode 211a and the second electrode 211b, in which case it is convenient to place the power receiving device in a flexible way. As required, the distance of the insulation gap 212 can also be adjusted to be arranged unequally or irregularly, in which case the distance of the conductive contact of the power receiving device needs to be adjusted correspondingly.

Further, in order to prevent the power receiving device from exceeding the power supply range by the electrode of the wireless charging device 200, a limit flange 213 is also disposed around the periphery of the second electrode 211b so that the power receiving device can be placed within a range defined by the limit flange 213 to ensure the electrical contact between the conductive contact and the electrode.

Other structures and working principle in this embodiment are the same as those of the first embodiment, therefore, which are not repeated here.

In addition, this disclosure is described through embodiments. However, this disclosure is not limited to those embodiments. The skilled in the art know that various modifications can be made without departing from the scope of this disclosure.

1-10. (canceled)

11. A wireless charging method, comprising following steps:
S1: setting electrodes of a wireless charging device to a detection state;
S2: detecting whether the electrodes are in contact with a conductive contact of a power receiving device;
S3: determining association between all the electrodes that are in contact with the conductive contact, and setting polarity of the electrodes respectively; and
S4: connecting to a power source corresponding to the polarity according to the polarity of the electrodes.

12. The wireless charging method of claim 11, wherein in the step S1, a micro voltage is loaded onto the electrodes so as to make the electrodes be in a to-be-detected state.

13. The wireless charging method of claim 12, wherein in the step S2, the electrodes are determined to be in contact with the conductive contact when the micro voltage on the electrodes changes.

14. The wireless charging method of claim 11, wherein there are a plurality of the electrodes;
wherein in the step S3, one of the electrodes which is in contact with the conductive contact is taken as a reference while scanning the remaining electrodes successively, wherein the electrode in short connection with the electrode as the reference is set as a same polarity while the electrode not in short connection with the electrode as the reference is set as a different polarity.

15. The wireless charging method of claim 14, wherein each of the electrodes is connected with a positive switching circuit and a negative switching circuit;
in the step S4, the positive switching circuit or the negative switching circuit correspondingly connected with the electrodes is controlled to be switched on according to the polarity set in the step S3 so as to connect the power receiving device to the power source.

16. The wireless charging method of claim 12, wherein there are a plurality of the electrodes;
wherein in the step S3, one of the electrodes which is in contact with the conductive contact is taken as a reference while scanning the remaining electrodes successively, wherein the electrode in short connection with the electrode as the reference is set as a same polarity while the electrode not in short connection with the electrode as the reference is set as a different polarity.

17. The wireless charging method of claim 16, wherein each of the electrodes is connected with a positive switching circuit and a negative switching circuit;
in the step S4, the positive switching circuit or the negative switching circuit correspondingly connected with the electrodes is controlled to be switched on according to the polarity set in the step S3 so as to connect the power receiving device to the power source.

18. The wireless charging method of claim 13, wherein there are a plurality of the electrodes;
wherein in the step S3, one of the electrodes which is in contact with the conductive contact is taken as a reference while scanning the remaining electrodes successively, wherein the electrode in short connection with the electrode as the reference is set as a same polarity while the electrode not in short connection with the electrode as the reference is set as a different polarity.

19. The wireless charging method of claim 18, wherein each of the electrodes is connected with a positive switching circuit and a negative switching circuit;
in the step S4, the positive switching circuit or the negative switching circuit correspondingly connected with the electrodes is controlled to be switched on according to the polarity set in the step S3 so as to connect the power receiving device to the power source.

20. A wireless charging device, comprising at least two electrodes and a power supply circuit; wherein the at least two electrodes are arranged separately and operable for contacting with a conductive contact of a power receiving device; the power supply circuit is electrically connected with the electrodes and operable to provide power supply according to association between all the electrodes that are in contact with the conductive contact.

21. The wireless charging device of claim 20, wherein the power supply circuit comprises a detection circuit, a switching circuit, a control circuit and a power circuit; the power circuit is connected with the detection circuit, the switching circuit and the control circuit for supplying power;
the detection circuit is electrically connected with each of the electrodes for detecting whether the electrodes are in contact with the conductive contact;
the switching circuit is electrically connected with each of the electrodes for switching on or switching off the power supply of the electrodes;
the control circuit is connected with the detection circuit and the switching circuit; wherein based on whether each of the electrodes is in contact with the conductive contact detected by the detection circuit, the control circuit is operable to send out a control signal to the switching circuit so that each of the electrodes is controlled to connect to or disconnect from the power circuit.

22. The wireless charging device of claim 21, wherein the control circuit comprises a detection setting module; the detection setting module is operable to take one of the electrodes that is in contact with the conductive contact as a reference while scanning the remaining electrodes, wherein the electrode in short connection with the electrode as the reference is set as a same polarity and the electrode not in short connection with the electrode as the reference is set as a different polarity;
the control module is operable to output an on-off control signal to the switching circuit according to a setting result of the detection setting module.

23. The wireless charging device of claim 21, wherein the switching circuit comprises a positive switching circuit and a negative switching circuit which are simultaneously connected with each of the electrodes;
the detection circuit comprises a plurality of detection units, wherein each of the detection units is electrically connected with one of the electrodes;
the positive switching circuit comprises a plurality of positive switching units, wherein each of the positive switching units is electrically connected with one of the electrodes;
the negative switching circuit comprises a plurality of negative switching units, wherein each of the negative switching units is electrically connected with one of the electrodes;
the positive switching unit and the negative switching unit connected with the same electrode are controlled by the control circuit to be alternatively switched on or simultaneously switched off.

24. The wireless charging device of claim 22, wherein the switching circuit comprises a positive switching circuit and a negative switching circuit which are simultaneously connected with each of the electrodes;
the detection circuit comprises a plurality of detection units, wherein each of the detection units is electrically connected with one of the electrodes;
the positive switching circuit comprises a plurality of positive switching units, wherein each of the positive switching units is electrically connected with one of the electrodes;
the negative switching circuit comprises a plurality of negative switching units, wherein each of the negative switching units is electrically connected with one of the electrodes;
the positive switching unit and the negative switching unit connected with the same electrode are controlled by the control circuit to be alternatively switched on or simultaneously switched off.

25. The wireless charging device of claim 20, wherein the electrodes and the power supply circuit are integrally arranged with each other; or, the electrodes and the power supply circuit are separately arranged and electrically connected with each other through wire or contact.
